(19) United States
(12) Patent Application Publication
(10) Pub. No.: US 2015/0027250 A1
(43) Pub. Date: Jan. 29, 2015

(54) Tensile loaded leadscrew drive

(71) Applicant: David Rogers Campbell, Richland, WA (US)

(72) Inventor: David Rogers Campbell, Richland, WA (US)

(21) Appl. No.: 13/987,422

(22) Filed: Jul. 24, 2013

(51) Int. Cl. F16H 25/20

(52) U.S. Cl. CPC F16H 25/2003
USPC 74/89.23

(57) ABSTRACT

An improved leadscrew drive uses thrust bearings with a mechanical space between a bearing and its support allowing the leadscrew and bearings to move axially, placing the leadscrew in tensile loading, eliminating leadscrew columnar buckling and allowing the use of a smaller diameter and finer pitch lead leadscrew.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

A leadscrew drive is a mechanical power transmission device with torque on a leadscrew driving a load attached to a nut. Leadscrews are analyzed by two mechanical theories as far as the screws length is concerned, loading in tension, and in columnar loading, with a tendency in columnar loading to buckle the screw if forces are too large. The columnar case is a more restrictive limit to lead screw maximum length as it depends on the slenderness ratio, whereas the tension case is dependent on diameter only, if the material type and length are the same in both cases. Columnar loading requires a larger leadscrew diameter, which is wasted in the tension case. The larger diameter required by the columnar case reduces the number of leadscrew pitches available, since larger diameter leadscrews have a coarser pitches, which tends to prevent design to move heavier loads with finer leadscrew pitches.

An improvement is advertised by the igus Corporation in the columnar loading performance of a leadscrew drive where leadscrew is used to drive a carriage. Two intermediate carriages known as a long leadscrew supports, that bear no load, support the length of the leadscrew that tends to buckle. This is an expensive alternative as two other mechanisms, with precision bearings, are required, and the additional mechanisms do not support or move the load. The mechanisms require additional design to place them in the center of the unsupported leadscrew span, which reduces the travel of the loaded carriage, as the leadscrew supports consume lineal space through which the loaded carriage cannot move. The overall length of the drive must be increased, which somewhat defeats the purpose of the improvement as the overall unsupported length of the leadscrew is unchanged.

### BRIEF SUMMARY OF THE INVENTION

The present Invention eliminates columnar loading and the resulting deformation of a leadscrew, allowing a reduction in leadscrew diameter and increased pitch. Under the following conditions—a load applied to the leadscrew nut, the load being approximately zero with the nut centered between the leadscrew ends and the load increasing as the nut moves either side of center—a mechanical clearance between the leadscrew bearings and their supports allows the leadscrew to move axially, placing the leadscrew thrust load on one thrust bearing, and the unsupported leadscrew, between the nut and nearest bearing, in tension.

### BRIEF DESCRIPTION OF THE SEVERAL VIEWS OF THE DRAWINGS

FIG. 1 is a front view of the Invention, (1) is the leadscrew, (2) is the leadscrew nut, (3) is a leadscrew bearing support and (4) is the leadscrew thrust bearing. A small mechanical clearance (5) between (3) and (4) allows (1) and (4) to move axially to load the left side of (1), with respect to (2), in tension.

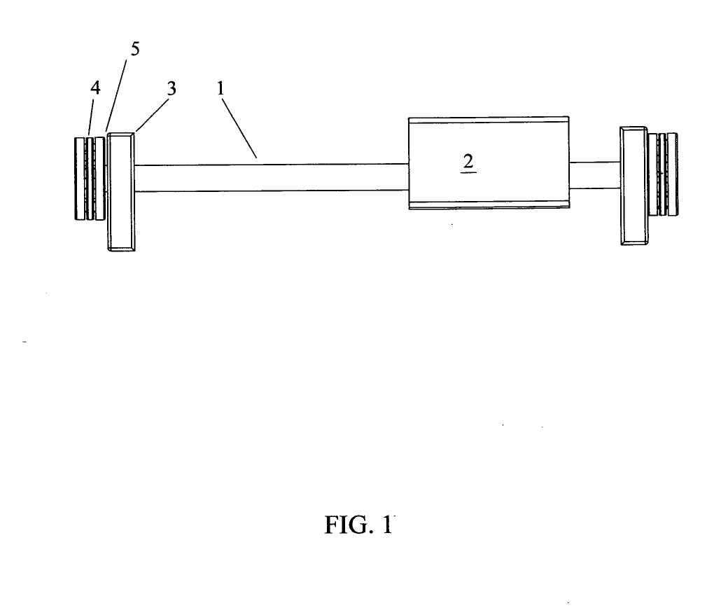

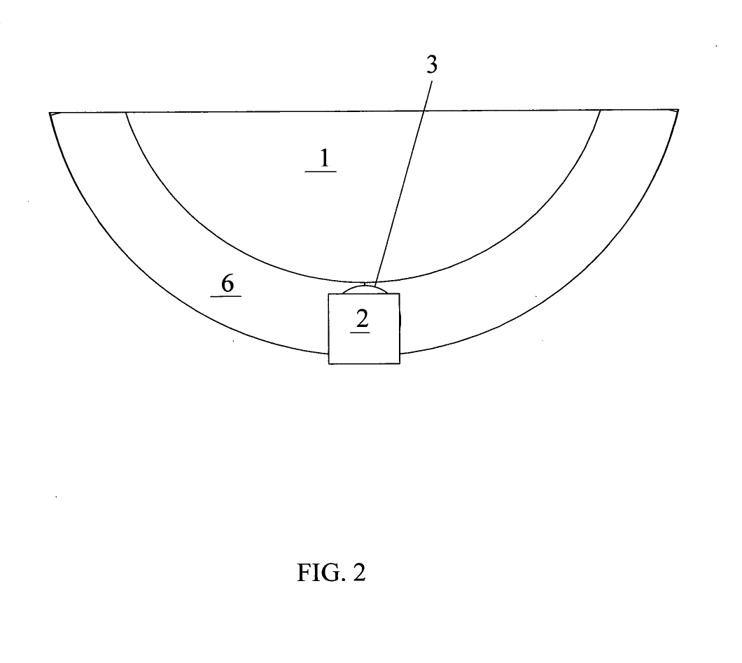

### DETAILED DESCRIPTION OF THE INVENTION

The present Invention uses a leadscrew drive to rotate a cantilever beam from vertical, with no-load, to horizontal, at maximum load. The system is designed to move the cantilever load either side of vertical; for simplification only one direction is assumed.

Leadscrews have a limitation of requiring a larger diameter, for strength, when the leadscrew is in compression or columnar loading than in tensile loading. Tensile loading relies on the tensile strength of the leadscrews material and its cross section, and the maximum tensile loading is the same regardless of the leadscrews length. The columnar case is significantly limited by the length of the unsupported portion of the leadscrew; requiring a larger leadscrew diameter for the same load as in tensile. Both cases are present in the same leadscrew, with the columnar loading case, not the lesser restrictive tensile case, determining the leadscrew diameter and maximum length. It is impossible to separate the two cases in one leadscrew. The non-obvious problem is that the columnar loading case implies a coarser leadscrew pitch, for standard leadscrew stock, which means that the resolution, per leadscrew turn, of the motion in the columnar case is lesser than that for the tensile loaded case, all other factors being equal.

Leadscrews require bearings on each end. If the leadscrew nut bears the radial load, then the bearings can be thrust loaded. The leadscrew load must place the bearings in thrust. This implies the leadscrew, between the nut and the bearing, is in tension. When the nut moves the load, a slight clearance between either of the bearings and their supports, or between the races of one bearing, allows the leadscrew to move along its axis so a bearing is in contact and it bears the leadscrew load, causing the force in the leadscrew to be in tension.

Since all the leadscrews load is in tension, its minor diameter and pitch can be selected for the tensile case, instead of for columnar loading, and a smaller leadscrew with a finer pitch can be selected compared to the normal selection process for a leadscrew based on columnar loading.

The inventor claims:

1. An improved leadscrew drive where the improvement comprises:
a. a leadscrew whose minor diameter and pitch are defined by the tensile loaded case,
b. a thrust bearing on each end of said leadscrew,
c. a mechanical support for each of said bearings against which each may bear a thrust load,
d. a leadscrew nut to couple a mechanical load to said leadscrew,
e. a mechanical clearance, between either of said bearings and its support, that allows said leadscrew and bearings to move axially with respect to said bearings centerline.

2. Rotation of said leadscrew and reaction of said load on said nut causing said leadscrew to move axially so that one of said bearings is in thrust loading, and the portion of said leadscrew between said thrust loaded bearing and said nut is in tensile loading.
